(19) United States
(12) Patent Application Publication
(10) Pub. No.: US 2026/0319866 A1
(43) Pub. Date: Oct. 15, 2026

(54) INTER-CORE COMMUNICATION SYSTEM AND CHIP CIRCUIT

(71) Applicant: Black Sesame Technologies Co., Ltd., Wuhan (CN)

(72) Inventor: Shengnan Li, Shenzhen (CN)

(21) Appl. No.: 19/461,401

(22) Filed: Jan. 27, 2026

(30) Foreign Application Priority Data
Feb. 17, 2025 (CN) 2025101742878

(51) Int. Cl. G06F 9/54

(52) U.S. Cl. CPC G06F 9/544

(57) ABSTRACT

An inter-core communication system, comprising subsystems and message routing modules. Each subsystem includes a message buffer module and one or more processor cores respectively connected to the message buffer module. Each processor core serves as a producer core or a consumer core. The producer core is configured to write a transfer message into the message buffer module integrated in the subsystem where the producer core is located. The consumer core is configured to read the transfer message from the message buffer module integrated in the subsystem where the consumer core is located. The message routing module is configured to acquire the transfer message written by the producer core into the message buffer module integrated in the subsystem where the producer core is located, and route the acquired transfer message to the message buffer module integrated in the subsystem where the consumer core is located.

### RELATED APPLICATION

This application claims the benefit under 35 U.S.C. § 119(a) of the filing date of Chinese Patent Application No. 2025101742878, filed in the Chinese Patent Office on Feb. 17, 2025. The disclosure of the foregoing application is herein incorporated by reference in its entirety.

### TECHNICAL FIELD

The present disclosure relates to the field of system-on-chip (SoC) technologies, and in particular, to an inter-core communication system and a chip circuit.

### BACKGROUND

With the rapid development of semiconductor technologies, an integration scale of SoCs has shown a continuous expansion trend, with functions becoming increasingly rich and diverse. Currently, to meet various complex application scenarios and diverse requirements, an SoC chip is generally divided into a plurality of subsystems according to functions. Each subsystem is equipped with a processor and corresponding processor cores, and the subsystems cooperate to form a heterogeneous system. In such a heterogeneous system, communication efficiency between the processor cores becomes a key factor affecting operating efficiency of the entire SoC.

### SUMMARY

In one aspect of the present disclosure, an inter-core communication system is provided, including one or more subsystems, each of the subsystems including a message buffer module and one or more processor cores respectively connected to the message buffer module via a bus, each of the processor cores servings as a producer core or a consumer core, the producer core being configured to write a transfer message into the message buffer module integrated in the subsystem where the producer core is located, and the consumer core being configured to read the transfer message from the message buffer module integrated in the subsystem where the consumer core is located; and one or more message routing modules configured to: acquire the transfer message written by the producer core into the message buffer module integrated in the subsystem where the producer core is located, and route the acquired transfer message to the message buffer module integrated in the subsystem where the consumer core is located.

In some embodiments, each of the message buffer modules includes: one or more buffer processing units respectively corresponding to one or more processor cores in the subsystem where the message buffer module where the buffer processing units reside is located, each of the buffer processing units including a send buffer and a receive buffer; and an internal routing unit configured to acquire the transfer message, and route the transfer message to the receive buffer of the buffer processing unit included in the message buffer module where the internal routing unit is located; wherein the consumer core is further configured to read the transfer message from the receive buffer in the buffer processing unit corresponding thereto.

In some embodiments, the message buffer module is further configured to write the transfer message into the send buffer in the buffer processing unit corresponding to the producer core, the send buffer being configured to transfer the transfer message to the internal routing unit; the internal routing unit is further configured to acquire the transfer message from the send buffer in the buffer processing unit, and route, when the producer core and the consumer core are located in a same subsystem, the acquired transfer message to the receive buffer in the buffer processing unit corresponding to the consumer core; and route, when the producer core and the consumer core are located in different subsystems, the acquired transfer message to the message routing module; and the message routing module is further configured to route the acquired transfer message to the internal routing unit in the message buffer module in the subsystem where the consumer core is located.

In some embodiments, the internal routing unit is further configured to acquire the transfer message from the message routing module, and route the transfer message to the receive buffer in the buffer processing unit corresponding to the consumer core.

In some embodiments, the buffer processing unit is further configured to send, in response to a number of the transfer message in the receive buffer in the buffer processing unit being greater than or equal to a predetermined number, an interrupt signal to the processor core corresponding to the buffer processing unit, to enable the processor core to serve as the consumer core to read the transfer message from the receive buffer.

In some embodiments, the transfer message includes: a producer core identifier field used to identify the producer core from which the transfer message originates, and a consumer core identifier field used to identify the consumer core to which the transfer message is to be sent.

In some embodiments, the internal routing unit is further configured to: discard the transfer message when both the producer core indicated by the producer core identifier field in the transfer message and the consumer core indicated by the consumer core identifier field in the transfer message are not located in the subsystem where the internal routing unit is located.

In some embodiments, the producer core identifier field is further used to identify a message buffer module included in the subsystem where the producer core is located and a buffer processing unit corresponding to the producer core, and the consumer core identifier field is further used to identify a message buffer module included in the subsystem where the consumer core is located and a buffer processing unit corresponding to the consumer core.

In some embodiments, the buffer processing unit is further configured to convert a format of the transfer message in the receive buffer in the buffer processing unit based on a width of the bus connecting the message buffer module where the buffer processing unit is located to the one or more processor cores.

In some embodiments, the buffer processing unit further includes: one or more message filters, the message filters respectively corresponding to different buffer address segments in the receive buffer; the one or more message filters being each configured to receive the transfer message from the internal routing unit, filter the received transfer message based on a respective filtering rule, and write a filtered transfer message to the corresponding buffer address segment.

In some embodiments, the buffer processing unit is further configured to receive configuration parameters, and set, based on the configuration parameters, actually enabled message filters, a filtering rule of each message filter, and ranges of the buffer address segments.

In some embodiments, each of the message filters includes one or more filtering units, the filtering units respectively filtering different parts of the transfer message based on respective filtering algorithms, to obtain unit filtering results of the filtering units; and the buffer processing unit is further configured to set actually enabled filtering units in each message filter based on the configuration parameters, and apply rules of the unit filtering results of the filtering units in the message filter, to set the filtering rule of each message filter.

In some embodiments, the buffer processing unit is further configured to send, in response to a number of the transfer message in any buffer address segment of the receive buffer in the buffer processing unit being greater than or equal to the predetermined number, an interrupt signal corresponding to the buffer address segment to the processor core corresponding to the buffer processing unit, to enable the processor core to serve as the consumer core to read the transfer message from the buffer address segment that is in the receive buffer and corresponds to the interrupt signal; and interrupt signals corresponding to different buffer address segments have different interrupt priorities.

In some embodiments, the buffer processing unit is further configured to: calculate a send check code based on the transfer message written into the send buffer, and append the send check code to the transfer message; and calculate a receive check code based on the transfer message written into the receive buffer, and compare the receive check code with the send check code appended to the transfer message, to determine whether a transmission error occurs in the transfer message.

In some embodiments, a plurality of subsystems are classified into one or more subsystem clusters according to implemented functions and locations, each of the subsystem clusters corresponding to one message routing module, and each of the subsystems being connected to the message routing module corresponding to the subsystem cluster to which the subsystem belongs.

In another aspect of the present disclosure, a chip circuit is provided, including the inter-core communication system according to the embodiments of the present disclosure.

In yet another aspect of the present disclosure, a chip circuit is provided, including: one or more processor cores, a transfer message being transmitted between the one or more processor cores; and one or more buffer processing units in one-to-one correspondence to the one or more processor cores, each of the buffer processing units including: a parameter register configured to store configuration parameters for configuring the buffer processing unit; a send buffer configured to buffer a transfer message to be sent by the processor core corresponding to the buffer processing unit where the send buffer is located; and a receive buffer configured to a buffer transfer message to be received by the processor core corresponding to the buffer processing unit where the receive buffer is located; wherein an address space in each of the buffer processing units is divided into two parts, one part being used to access the parameter register, and the other part being used to access the send buffer and the receive buffer.

According to the inter-core communication system and the chip circuit in the present disclosure, each subsystem includes a message buffer module serving as a transmission node for the transfer message, and the transmission nodes are integrated in the subsystems in a distributed manner. Transmission links (or transmission paths) for the transfer message from the processor core to the message buffer module and from the message buffer module to the processor core are relatively short, enabling the processor core in the subsystem to access the transmission node more quickly. The processor cores are connected, via a bus, to the message buffer module included in the subsystem where the processor cores are located, and a smaller number of processor cores are connected to the same bus, which reduces a load of data transmission on the bus and prevents bus congestion to some extent. Each message buffer module is connected to the corresponding message routing module, enabling communication of the transfer message between the message buffer modules via the message routing module, thereby realizing inter-core communication between a plurality of processor cores. According to the inter-core communication system in the present disclosure, the processor cores exhibit lower latency during inter-core communication, thereby reducing a load on the processor in each subsystem. Moreover, the inter-core communication system employs a distributed architecture, having excellent scalability.

### BRIEF DESCRIPTION OF THE DRAWINGS

FIG. 1 is a schematic diagram of an inter-core communication system according to embodiments of the present disclosure;

FIG. 2 is a schematic diagram of configuration of subsystems in the inter-core communication system according to embodiments of the present disclosure;

FIG. 3 is a schematic diagram of operating logic for routing a unicast transfer message by a module;

FIG. 4 is a schematic diagram of operating logic for routing a broadcast transfer message;

FIG. 5 is a schematic diagram of configuration of a message buffer module according to embodiments of the present disclosure;

FIG. 6 is a schematic diagram of a format of a transfer message according to embodiments of the present disclosure;

FIG. 7 is a schematic diagram of configuration of a buffer processing unit according to embodiments of the present disclosure;

FIG. 8 is a schematic diagram of an example of a corresponding relationship between message filters and buffer address segments in a receive buffer according to embodiments of the present disclosure; and

FIG. 9 is a schematic diagram of a communication process of a transfer message in an inter-core communication system according to embodiments of the present disclosure.

### DETAILED DESCRIPTION

In existing SoCs, a shared memory technology is typically employed to enable communication between a plurality of processor cores distributed across a plurality of subsystems. A shared memory refers to a memory region that can be directly accessed by cores of a plurality of processors (e.g., CPUs). In a multi-core system, processes or threads running on different processor cores often require frequent data exchange. A plurality of processor cores share the same system bus to access the shared memory, thereby transmitting data through the shared memory.

In the shared memory technology, the shared memory is locked and released relying on bus mutex operations and atomic operations, and data entering and exiting the shared memory also requires complex processes such as memory controller scheduling and row/column address decoding, which increases read/write latency, complicates an operation flow, leads to a large delay, and results in lower efficiency. As a chip has a growing scale and an increasingly complex SoC architecture, a path for each processor core to access the shared memory becomes longer, resulting in significant access latency. Since data requests are quite time-consuming in a bus transmission process, the processors are forced to remain in a waiting state for extended periods, severely impacting overall system performance and resulting in poor scalability.

The present disclosure provides an inter-core communication system based on a distributed architecture, which effectively reduces latency during inter-core communication and achieves excellent scalability.

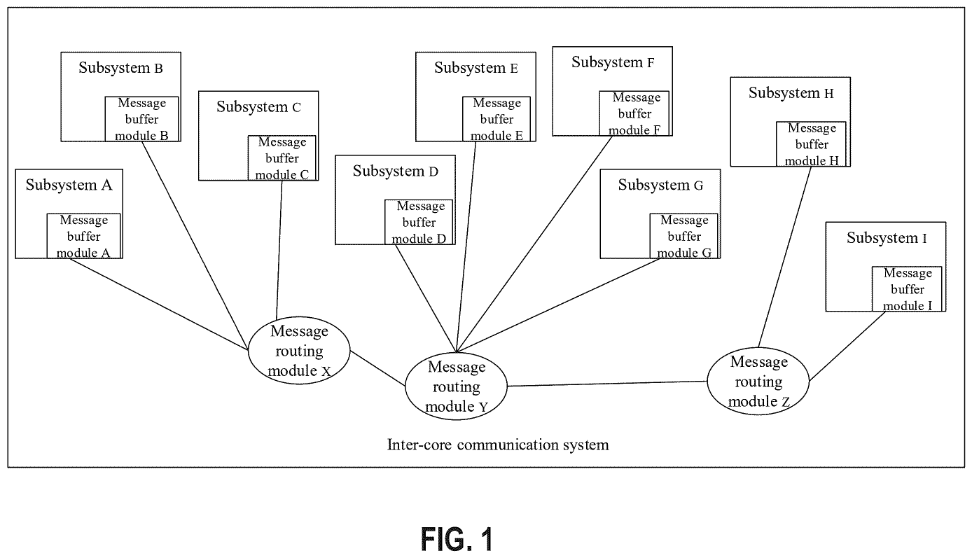

FIG. 1 is a schematic diagram of an inter-core communication system according to embodiments of the present disclosure. The inter-core communication system is configured for communication between a plurality of processor cores, for example, message transfer between the plurality of processor cores. The communication between the plurality of processor cores may be communication between a plurality of processor cores in the same processor or communication between processor cores in different processors. The communication between the plurality of processor cores may be communication between a plurality of processor cores in a same subsystem or communication between a plurality of processor cores in different subsystems. The inter-core communication system according to the present disclosure may be applied to an SoC. In the present disclosure, transmission of a transfer message between the plurality of processor cores is performed via a hardware link.

The inter-core communication system according to the embodiments of the present disclosure includes one or more subsystems and one or more message routing modules.

FIG. 1 illustrates, as an example, that the inter-core communication system includes a plurality of subsystems A to I and a plurality of message routing modules. It is easy to understand that the inter-core communication system in the present disclosure may include only one subsystem and only one message routing module. The subsystems A to I are subsystems in an SoC, which are partitioned according to implemented functions. That is, circuits and components in a chip are categorized into one or more subsystems according to functions and effects, and each subsystem has independent functional logic. For example, the subsystems may be a security subsystem, a protection subsystem, a media subsystem, a peripheral control subsystem, and the like in the SoC respectively.

The message routing modules may be modules outside the subsystems A to I in an SoC system, which may be understood as logic circuits configured to implement functions such as forwarding and routing of the transfer message. Specific configuration of the message routing module will be described hereinafter.

Each subsystem includes a message buffer module and one or more processor cores each connected to the message buffer module via a bus.

The subsystems A to I include message buffer modules A to I, respectively. A message buffer module is integrated in each subsystem to serve as a transmission node for the transfer message. The message buffer module may be understood as a logic circuit configured to implement functions such as decoding, buffering, and forwarding of the transfer message. For example, each subsystem includes one message buffer module. Specific configuration of the message buffer module will be described hereinafter.

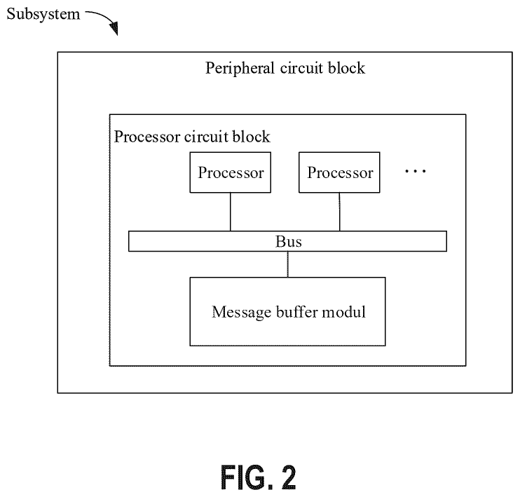

FIG. 2 is a schematic diagram of configuration of subsystems in the inter-core communication system according to embodiments of the present disclosure. FIG. 2 illustrates the configuration of only one subsystem. It is easy to understand that the subsystems in the inter-core communication system of the present disclosure have a similar configuration.

As shown in FIG. 2, the subsystem includes a processor circuit block and a peripheral circuit block. The peripheral circuit block includes circuit components configured to implement the functions of the subsystem. The peripheral circuit blocks of the subsystems may be different. The processor circuit block integrates a series of key components and circuits that are closely related to the processor. One or more processors are integrated in the processor circuit block. Each processor may be a single-core processor or a multi-core processor. That is, each processor includes one or more processor cores. In the present disclosure, the message buffer module is integrated in the processor circuit block. In the processor circuit block, all processor cores in the processor circuit block are connected to the message buffer module via a bus, and the transfer message may be transmitted between the message buffer module and the processor core via the bus. The transfer message is transmitted in the SoC via a hardware link. The message buffer module is integrated in the processor circuit block of each subsystem, and transmission links (or transmission paths) for the transfer of messages from the processor core to the message buffer module and from the message buffer module to the processor core are relatively short, enabling the processor core in the subsystem to access the message buffer module more quickly. In the present disclosure, the bus is, for example, an advanced high performance bus (AHB).

Each message buffer module corresponds to all processor cores in the subsystem where the message buffer module is located. All the processor cores in each subsystem are connected to the corresponding message buffer module (i.e., the message buffer module integrated in the subsystem where the processor cores are located) via a bus. Each subsystem has an independent bus. The bus in each subsystem is required only to connect the processor cores in the subsystem, rather than connecting all the processor cores in all the subsystems of the inter-core communication system to the same bus, which thus reduces a load of data transmission on the bus in each subsystem, and prevents bus congestion to some extent, thereby reducing a waiting time for the processor to send data.

Each processor core is a producer core or a consumer core. The producer core is a processor core responsible for generating data or resources, and the consumer core is a processor core responsible for using or processing such data or resources. In the inter-core communication system according to the present disclosure, the producer core generates and sends a transfer message, and the consumer core receives and uses the transfer message. It is easy to understand that both the producer core and the consumer core are processor cores in the inter-core communication system, which are merely role divisions during inter-core communication. A processor core in the inter-core communication system serves as a producer core when generating and sending a transfer message, and serves as a consumer core when receiving and using the transfer message. A recipient of the transfer message may be one or more consumer cores. That is, a transfer message generated by one producer core may be transmitted to one or more consumer cores.

The producer core and the consumer core may be in the same subsystem or in different subsystems. The producer core and the consumer core may be in the same processor or in different processors. In some examples, each subsystem includes at least one of the producer core and the consumer core.

The producer core is configured to write a transfer message into the message buffer module integrated in the subsystem where the producer core is located, and the consumer core is configured to read the transfer message from the message buffer module integrated in the subsystem where the consumer core is located.

For example, when the producer core is located in the subsystem A, the producer core is configured to write, via a bus, a transfer message into the message buffer module A connected thereto. When the consumer core is located in the subsystem D, the consumer core is configured to read, via the bus, the transfer message from the message buffer module D connected thereto. That is, the message buffer module D transmits, via the bus, the transfer message to the consumer core connected thereto.

The one or more message routing modules are each connected to the message buffer module in at least one subsystem corresponding thereto. Each message routing module corresponds to at least one subsystem in the inter-core communication system, and thus each message routing module corresponds to at least one message buffer module in the inter-core communication system and each message routing module is connected to at least one message buffer module corresponding thereto. It is easy to understand that each subsystem and each message buffer module have a corresponding message routing module, and correspond to only one message routing module. When the inter-core communication system includes a plurality of message routing modules, the message routing modules are interconnected, and the transfer message can be transmitted between the plurality of message routing modules.

For example, as shown in FIG. 1, message routing modules X, Y, and Z are interconnected, the message routing module X is connected to message buffer modules A, B, and C, the message routing module Y is connected to message buffer modules D, E, F, and G, and the message routing module Z is connected to message buffer modules H and I. The “connection” above refers to a connection via a hardware link. Transfer messages may communicate, via hardware links, between the message buffer modules and the message routing modules corresponding thereto and between the plurality of message routing modules.

It should be understood that the inter-core communication system may include only one message routing module. In this case, the message buffer modules in all the subsystems are connected to this message routing module.

The message routing module is configured to acquire the transfer message written by the producer core into the message buffer module integrated in the subsystem where the producer core is located, and route the acquired transfer message to the message buffer module integrated in the subsystem where the consumer core is located.

For example, when the producer core is located in the subsystem A and the consumer core is located in the subsystem D, the producer core writes, via a bus, a transfer message to the message buffer module A connected thereto, the message routing module X acquires, via a hardware link, the transfer message written by the producer core to the message buffer module A, that is, the message buffer module A transmits the transfer message written by the producer core to the message routing module X, the message routing module X transmits the transfer message to the message routing module Y, the message routing module Y routes the transfer message to the message buffer module D, and the consumer core reads, via the bus, the transfer message from the message buffer module D connected thereto. That is, the message buffer module D transmits, via the bus, the transfer message to the consumer core connected thereto. Therefore, the transfer message is transmitted from the producer core to the consumer core.

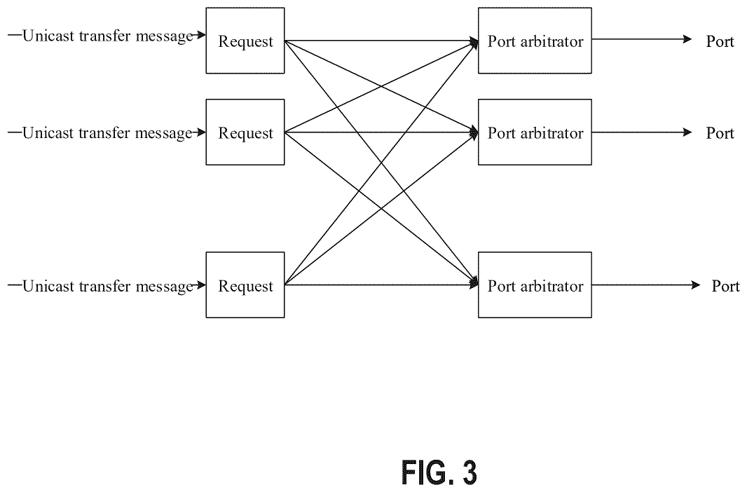

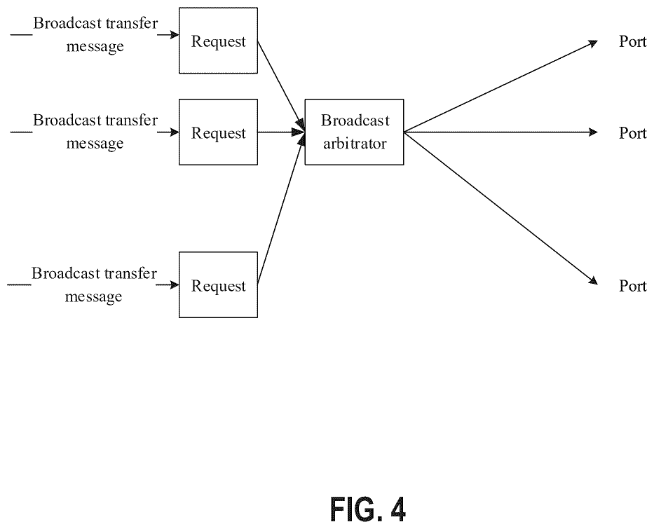

Operating logic for routing a transfer message by a message routing module is described below with reference to FIG. 3 and FIG. 4.

FIG. 3 is a schematic diagram of operating logic for routing a unicast transfer message by a module. The unicast transfer message means that one transfer message has only one destination for receiving the transfer message. The message routing module acquires (receives) the transfer message and sends, based on the transfer message, a request to a port (i.e., an output port) connected to the corresponding destination (such as the message buffer module integrated in the subsystem where the consumer core is located). Each transfer message corresponds to a request. A port arbitrator is correspondingly configured for each port. When a plurality of requests simultaneously attempt to send transfer messages to thesame port, the port arbitrator arbitrates the plurality of requests to determine a sequence in which the transfer messages are output via the port. Therefore, the transfer message is outputted (transmitted) to the corresponding destination.

FIG. 4 is a schematic diagram of operating logic for routing a broadcast transfer message. The broadcast transfer message means that one transfer message has a plurality of destinations for receiving the transfer message. The transfer message is to be transferred to all processor cores in the inter-core communication system except the processor core that sends the transfer message. That is, in the case of broadcast, all the processor cores in the inter-core communication system except for the producer core are consumer cores, and a plurality of consumer cores may exist during single transmission of the transfer message. The message routing module acquires (receives) the broadcast transfer message, and sends a broadcast request based on the transfer message. When acquiring (receiving) the broadcast transfer message, the message routing module sends a broadcast request, and temporarily suspends all other requests and arbitration functions of port arbitrators for output ports until all the output ports are idle. The message routing module transmits the broadcast transfer message simultaneously to all the output ports until the broadcast transfer message is routed to the destinations via the output ports, and the message routing module restores the arbitration functions of the port arbitrators for the output ports. When a plurality of broadcast transfer messages are simultaneously transmitted to the message routing module, broadcast arbitrators arbitrate a plurality of broadcast requests to determine a sequence in which the broadcast requests are processed. In the present disclosure, the arbitration algorithm for each arbitrator may adopt a Round Robin arbitration algorithm.

According to the above operating logic, the transfer message is routed by the message routing module and is routed via the corresponding port to the destination of the transfer message, for example, routed to the message buffer module integrated in the subsystem where the consumer core is located.

According to the inter-core communication system in the present disclosure, each subsystem includes a message buffer module serving as a transmission node for the transfer message, and the transmission nodes are integrated in the subsystems in a distributed manner. Transmission links (or transmission paths) for the transfer message from the processor core to the message buffer module and from the message buffer module to the processor core are relatively short, enabling the processor core in the subsystem to access the transmission node more quickly. The processor cores are connected, via a bus, to the message buffer module included in the subsystem where the processor cores are located, and a smaller number of processor cores are connected to the same bus, which reduces a load of data transmission on the bus and prevents bus congestion to some extent. Each message buffer module is connected to the corresponding message routing module, enabling communication of the transfer message between the message buffer modules via the message routing module, thereby realizing inter-core communication between a plurality of processor cores. According to the inter-core communication system in the present disclosure, the processor cores exhibit lower latency during inter-core communication, thereby reducing a load on the processor in each subsystem. Moreover, the inter-core communication system employs a distributed architecture, having excellent scalability.

In some embodiments, each message buffer module includes: one or more buffer processing units respectively corresponding to one or more processor cores in the subsystem where the message buffer module where the buffer processing units reside is located, wherein each buffer processing unit includes a send buffer and a receive buffer, and an internal routing unit configured to acquire the transfer message, and route the transfer message to the receive buffer of the buffer processing unit included in the message buffer module where the internal routing unit is located. The consumer core is further configured to read the transfer message from the receive buffer in the buffer processing unit corresponding thereto.

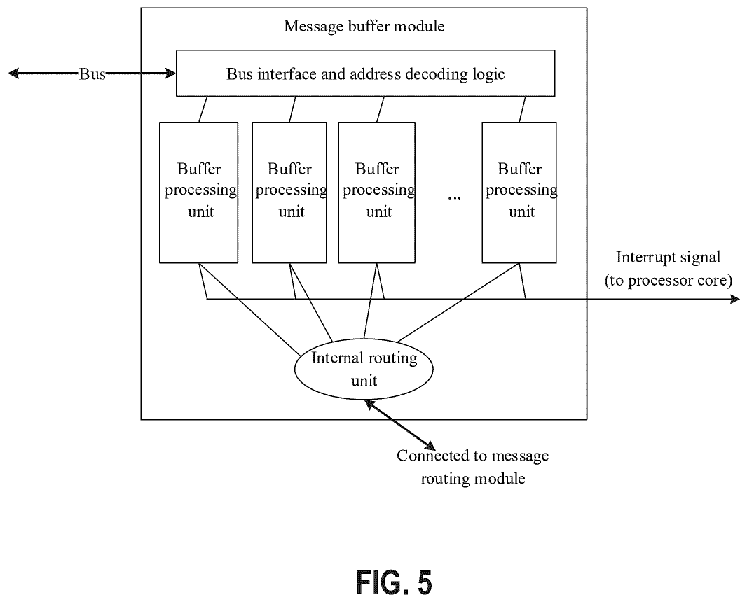

FIG. 5 is a schematic diagram of configuration of a message buffer module according to embodiments of the present disclosure. The message buffer module includes one or more buffer processing units. In each subsystem, the one or more buffer processing units are in one-to-one correspondence to the one or more processor cores in the subsystem where the message buffer module is located, that is, in one-to-one correspondence to the processor cores corresponding to the message buffer module. For example, when the subsystem A includes 5 processor cores, the message buffer module A includes at least 5 buffer processing units, and the 5 buffer processing units are in one-to-one correspondence to 5 processor cores in the subsystem A. It is easy to understand that, if the message buffer module A includes more than 5 buffer processing units, some of the buffer processing units may not be enabled. Each buffer processing unit includes a send buffer and a receive buffer, for example, one send buffer and one receive buffer, which are configured respectively to buffer transfer messages to be sent and to be received by the processor core corresponding to the buffer processing unit. The buffer processing unit is a sub-logic circuit in the message buffer module, which may be understood as an end in a transmission node. Specific configuration of the buffer processing unit will be described in detail later. For example, the send buffer and the receive buffer may be first input first output (FIFO) buffers.

The internal routing unit is configured to route the transfer message in the subsystem. For example, one message buffer module includes one internal routing unit. The internal routing unit may acquire a transfer message in the send buffer in the buffer processing unit, that is, acquire a transfer message transmitted by the send buffer to the internal routing unit, or may acquire a transfer message routed by the routing module to the internal routing unit. The internal routing unit corresponds to all buffer processing units in the message buffer module where the internal routing unit is located. The internal routing unit is connected to all the buffer processing units in the message buffer module where the internal routing unit is located. The “connection” above refers to a connection via a hardware link. The transfer message may communicate, via a hardware link, between the buffer processing unit and the internal routing unit corresponding thereto. As described above, the message buffer module is connected to the message routing module corresponding thereto. Specifically, the message buffer module is connected, via the internal routing unit therein, the message routing module corresponding thereto. That is, the transfer message may communicate, via a hardware link, between the internal routing unit and the message routing module corresponding thereto. Each message routing module corresponds to one or more internal routing units included in the one or more subsystems corresponding thereto.

The internal routing unit is a sub-logic circuit in the message buffer module. Operating logic of the internal routing unit is substantially the same as that of the message routing module. For details, please refer to the description of the operating logic of the message routing module and FIG. 3 and FIG. 4.

In some examples, when the message buffer module includes only one buffer processing unit, the buffer processing unit directly interacts with the message routing module connected to the message buffer module where the buffer processing unit is located. That is, the transfer message is transmitted without passing through the internal routing unit. Further, in this case, the message buffer module may not include the internal routing unit.

The internal routing unit may route the transfer message to the receive buffer of the buffer processing unit included in the message buffer module where the internal routing unit is located. That is, the internal routing unit may route the transfer message to the receive buffers in one or more buffer processing units corresponding thereto, so that the transfer messages transferred from the producer core can be buffered in the receive buffers. When a memory space of the receive buffer has reached an occupancy limit, for instance, when the memory space is fully occupied, a transfer message to be routed to the receive buffer will be discarded, thereby preventing data congestion and logical anomalies in the inter-core communication system. That is, a transfer message intended to be transmitted to the receive buffer of the buffer processing unit corresponding to the consumer core is discarded due to an insufficient memory space in the receive buffer, and therefore cannot be successfully transmitted to the consumer core. Correspondingly, to prevent discarding of the transfer message due to an insufficient memory space in the receive buffer, whether the transfer message is received by the consumer core may be monitored by software, and a corresponding timeout-based retransmission mechanism is configured.

The consumer core reads the transfer message from the receive buffer in the buffer processing unit corresponding thereto. The transfer message is generated and sent by the producer core, and is routed via the internal routing unit to the receive buffer in the buffer processing unit corresponding to the consumer core, thereby enabling the consumer core to obtain the transfer message. Therefore, the transfer message is transmitted from the producer core to the consumer core. In addition, through the arrangement of the internal routing unit, external links and interfaces of each subsystem are reduced.

In some embodiments, the message buffer module is further configured to write the transfer message into the send buffer in the buffer processing unit corresponding to the producer core, the send buffer is configured to transfer the transfer message to the internal routing unit, the internal routing unit is further configured to acquire the transfer message from the send buffer in the buffer processing unit, route, when the producer core and the consumer core are located in a same subsystem, the acquired transfer message to the receive buffer in the buffer processing unit corresponding to the consumer core, and route, when the producer core and the consumer core are located in different subsystems, the acquired transfer message to the message routing module, and the message routing module is further configured to route the acquired transfer message to the internal routing unit in the message buffer module integrated in the subsystem where the consumer core is located.

The message buffer module receives, via the bus, the transfer message written by the corresponding producer core, and a bus interface and address decoding logic in the message buffer module process the written transfer messages to identify the producer core from which the transfer message originates, so as to write the transfer message into the send buffer in the buffer processing unit corresponding to the producer core. The send buffer transfers the written transfer message to the internal routing unit corresponding to the buffer processing unit where the send buffer is located. That is, the send buffer transfers the written transfer message to the internal routing unit included in the message buffer module where the send buffer is located.

The internal routing unit identifies, based on the transfer message transferred from the send buffer, the producer core from which the transfer message originates, and identifies the destination of the transfer message, that is, identifies which processor core(s) in the inter-core communication system is/are the consumer core. When the producer core and the consumer core are located in the same subsystem, the transfer message may be transmitted inside the subsystem where they are located. In this case, the internal routing unit directly routes the transfer message received from the send buffer to the receive buffer in the buffer processing unit corresponding to the consumer core. When the producer core and the consumer core are located in different subsystems, the internal routing unit routes the transfer message received from the send buffer to the message routing module connected the internal routing unit.

The message routing module routes the transfer message acquired from the internal routing unit in the subsystem where the producer core is located to the internal routing unit in the subsystem where the consumer core is located. For example, when the producer core is located in the subsystem A and the consumer core is located in the subsystem B, the internal routing unit in the message buffer module A routes the transfer message to the message routing module A, and the message routing module A routes the transfer message to the internal routing unit in the message buffer module B. When the inter-core communication system includes a plurality of message routing modules, the transfer message may be transmitted between the plurality of message routing modules and finally be routed to the internal routing unit in the message buffer module in the subsystem where the consumer core is located. As described above, the internal routing unit can route the transfer message to the receive buffer of the corresponding buffer processing unit, so that the consumer core can acquire the transfer message. In the embodiments, the internal routing unit can acquire the transfer message from the send buffer, serving as a process of sending the transfer message by the message buffer module, and route the transfer message according to an actual situation. Therefore, the transfer message is transmitted from the producer core to the consumer core.

In some embodiments, the internal routing unit is further configured to acquire the transfer message from the message routing module, and route the transfer message to the receive buffer in the buffer processing unit corresponding to the consumer core.

The internal routing unit identifies the destination of the transfer message based on the transfer message transferred from the message routing module, and routes the transfer message to the receive buffer in the buffer processing unit corresponding to the consumer core, so that the consumer core can acquire the transfer message from the receive buffer in the buffer processing unit corresponding thereto. In the embodiments, the internal routing unit can acquire the transfer message from the message routing module, serving as a process of receiving the transfer message by the message buffer module, and route the transfer message to the receive buffer according to an actual situation. Therefore, the transfer message is transmitted from the producer core to the consumer core.

In some embodiments, the buffer processing unit is further configured to send, in response to a number of the transfer message in the receive buffer in the buffer processing unit being greater than or equal to a predetermined number, an interrupt signal to the processor core corresponding to the buffer processing unit, to enable the processor core to serve as the consumer core to read the transfer message from the receive buffer.

The number of the transfer message in the receive buffer in the buffer processing unit being greater than or equal to the predetermined number means that the transfer messages generated by the producer core and transmitted to the receive buffer in the buffer processing unit corresponding to the consumer core are buffered in the receive buffer and a number of the transfer messages buffered in the receive buffer is greater than or equal to the predetermined number. In this case, the buffer processing unit sends an interrupt signal to the consumer core to notify the consumer core to read the transfer message from the receive buffer of the buffer processing unit. More specifically, the transfer message is read via a bus connecting the consumer core to the message buffer module where the buffer processing unit is located. As described above, in each subsystem, the one or more buffer processing units are in one-to-one correspondence to the one or more processor cores in the subsystem where the message buffer module is located. That is, the buffer processing units are in one-to-one correspondence to the processor cores. When the number of the transfer message in the receive buffer in the buffer processing unit is greater than or equal to the predetermined number, which processor core in the inter-core communication system is the processor core corresponding thereto can be determined. The processor core, serving as a consumer core, will read the transfer message in the receive buffer.

The predetermined number may be flexibly set according to an actual situation. The predetermined number may be set according to a number of transfer messages in the receive buffer. For example, the predetermined number may be 1. In this way, once a transfer message is transmitted to the receive buffer, the corresponding processor core is immediately notified to serve as a consumer core to read the transfer message. The predetermined number may alternatively be more than one, for example, 10. In this way, when the number of the transfer messages buffered in the receive buffer is greater than or equal to 10, the corresponding processor core is notified to serve as a consumer core to read the transfer messages from the receive buffer. A number of the transfer message read by the consumer core from the receive buffer each time is determined according to an actual application, which is not limited herein. The predetermined number may be set by configuring a watermark of the receive buffer. When the number of the transfer messages in the receive buffer exceeds the watermark, the buffer processing unit where the receive buffer is located sends an interrupt signal to the corresponding consumer core. Therefore, a consumer core can acquire the transfer message sent by the producer core in a timely manner.

In some embodiments, the transfer message includes: a producer core identifier field used to identify the producer core from which the transfer message originates, and a consumer core identifier field used to identify the consumer core to which the transfer message is to be sent.

For example, the transfer message may include a message header and a payload. The message header generally carries key metadata, such as a source, a destination, and a type of the transfer message. When a transfer message is sent or received, the message header is sent or received first, enabling a receiving end to know in advance how to process subsequent data. The payload refers to a main content body of the transfer message.

In some examples, the transfer message may include only the message header but not the payload. That is, a length of the payload of the transfer message is 0. This means that the main body of the transfer message includes no specific data content to be actually transmitted, and includes only the message header. Such a message may serve a purpose of simple notification and synchronization between processor cores. For example, when a first processor core reaches a certain stage and is required to notify a second processor core to start next operation, such a transfer message that includes no payload and only a message header may be sent. After receiving the transfer message, the second processor core knows that a corresponding “event” is triggered and then takes an appropriate action. In this way, such a transfer message may be used to replace a function of an event in a current inter-process communication (IPC) mechanism.

The producer core identifier field and the consumer core identifier field may be included in the message header. When the producer core generates a transfer message, a producer core identifier field and a consumer core identifier field of the transfer message are determined. After receiving the transfer message written by the producer core, the message buffer module identifies, according to the producer core identifier field included in the transfer message via the bus interface and the address decoding logic therein, into the send buffer of which buffer processing unit the transfer message is to be written. When acquiring the transfer message from the send buffer, the internal routing unit determines, according to the consumer core identifier field included in the transfer message, a destination to which the transfer message is to be routed, that is, determines whether to route the transfer message to the receive buffer in a specific buffer processing unit or to the message routing module. When acquiring the transfer message from the internal routing unit, the message routing module determines, according to the consumer core identifier field included in the transfer message, the internal routing unit of the message buffer module in which subsystem in the inter-core communication system the transfer message is to be routed to. When acquiring the transfer message from the message routing module, the internal routing unit determines, according to the consumer core identifier field included in the transfer message, the receive buffer in which buffer processing unit the transfer message is to be routed. In short, during transmission of the transfer message, a producer core from which the transfer message originates and a consumer core to which the transfer message is to be transmitted are determined based on the producer core identifier field and consumer core identifier field included in the transfer message.

In some embodiments, the internal routing unit is further configured to: discard the transfer message when both the producer core indicated by the producer core identifier field in the transfer message and the consumer core indicated by the consumer core identifier field in the transfer message are not located in the subsystem where the internal routing unit is located.

When acquiring the transfer message, the internal routing unit may further determine whether the producer core identifier field and the consumer core identifier field of the transfer message indicate a processor core in the subsystem where the internal routing unit is located. When both the producer core identifier field and the consumer core identifier field do not indicate a processor core in the subsystem where the internal routing unit is located, that is, when both the producer core indicated by the producer core identifier field and the consumer core indicated by the consumer core identifier field are not located in the subsystem where the internal routing unit is located, the transfer message is discarded. This situation typically arises from a software error resulting in an incorrect transfer message. Discarding the incorrect transfer message prevents operational deadlock in the inter-core communication system.

In some embodiments, the producer core identifier field is further used to identify a message buffer module included in the subsystem where the producer core is located and a buffer processing unit corresponding to the producer core, and the consumer core identifier field is further used to identify a message buffer module included in the subsystem where the consumer core is located and a buffer processing unit corresponding to the consumer core.

The producer core identifier field may include two parts, the first part is used to identify a message buffer module included in the subsystem where the producer core is located, and the second part is used to identify a buffer processing unit corresponding to the producer core. Correspondingly, the consumer core identifier field may include two parts, the first part is used to identify a message buffer module included in the subsystem where the consumer core is located, and the second part is used to identify a buffer processing unit corresponding to the consumer core. Since the message buffer modules and the buffer processing units have a corresponding relationship with the processor cores, by identifying the message buffer modules and the buffer processing units, the processor core can be uniquely identified, thereby enabling determination of the producer core identifier field and the consumer core identifier field.

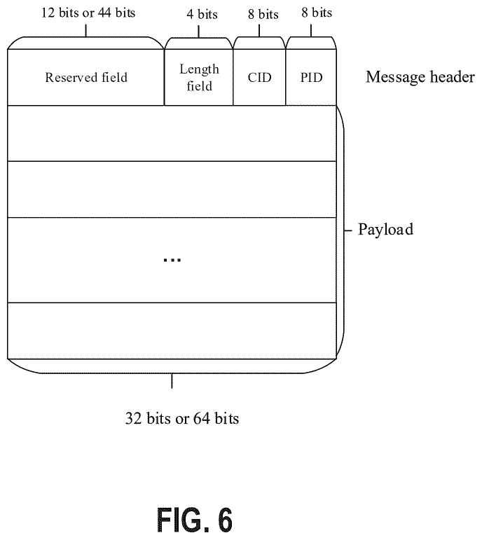

A format of the transfer message is described in detail below with reference to FIG. 6. FIG. 6 is a schematic diagram of a format of a transfer message according to embodiments of the present disclosure.

As shown in FIG. 6, a message header of the transfer message includes a producer core identifier field PID, a consumer core identifier field CID, a length field, and a reserved field. The transfer message further includes a payload. A width of the transfer message is consistent with a width of a bus connecting the processor core to the corresponding message buffer module. In practical applications, the width of the bus is typically 32 bits or 64 bits. Therefore, the width of the transfer message is typically 32 bits or 64 bits.

In the example shown in FIG. 6, the producer core identifier field PID and the consumer core identifier field CID are each 8 bits, and each is evenly divided into two parts: the first part includes high-order 4 bits, used to identify the message buffer module, and the second part includes low-order 4 bits, used to identify the buffer processing unit in the message buffer module. Both the producer core identifier field PID and the consumer core identifier field CID may uniquely identify the processor cores in the inter-core communication system. In particular, when the consumer core identifier field CID is 0 in all bits, it is used for function extension. When the consumer core identifier field CID is 1 in all bits, it indicates that the transfer message is broadcast. That is, the transfer message is to be transferred to all processor cores in the inter-core communication system except the processor core that sends the transfer message. In other words, all processor cores except the processor core that sends the transfer message serve as consumer cores.

The length field is used to indicate a length of the payload in the transfer message. For a transfer message with a width of 32 bits, the length of the payload may range from 0 to 9. For a transfer message with a width of 64 bits, the length of the payload may range from 0 to 4. In this case, a maximum size of one transfer message is 320 bits.

The reserved field may be defined by software according to an actual application. For the transfer message with a width of 32 bits, a length of the reserved field may be 12 bits. For the transfer message with a width of 64 bits, the length of the reserved field may be 44 bits. By configuring the reserved field, functions and applications of the transfer message can be extended. For example, when the above transfer message is used to replace the function of the event in the IPC mechanism, through the reserved field, the transfer message including only the message header may transfer some additional information.

In some embodiments, the buffer processing unit is further configured to convert a format of the transfer message in the receive buffer in the buffer processing unit based on a width of the bus connecting the message buffer module where the buffer processing unit is located to the one or more processor cores.

In different subsystems, the width of the bus connecting the message buffer module to one or more processor cores may vary. The transfer message can be effectively transmitted on the bus only by ensuring that the width of the transfer message is consistent with the width of the bus. For example, in the subsystem A, the width of the bus connecting the processor core to the message buffer module is 64 bits, while in the subsystem D, the width of the bus connecting the processor core to the message buffer module is 32 bits. If the transfer message is sent from the processor core in the subsystem A to the processor core in the subsystem D, the transfer message is 64 bits in width when generated by the producer core and written into the message buffer module in the subsystem A. In this case, the format of the transfer message is required to be converted to adapt to the width of the bus in the subsystem D, so that the consumer core in the subsystem D can acquire the transfer message via the 32-bit bus. The buffer processing unit converts the width of the transfer message in the receive buffer into the width of the bus connecting the message buffer module where the buffer processing unit is located to the one or more processor cores corresponding thereto.

As described above, in practical applications, the bus is typically 32 bits or 64 bits in width, and the transfer message is correspondingly 32 bits or 64 bits in width. The following serves as an example to illustrate mutual conversion of the transfer message between 32 bits and 64 bits.

To convert a transfer message with a width of 64 bits into a transfer message with a width of 32 bits, low-order 32 bits of a message header in the transfer message with a width of 64 bits are used as a message header in the transfer message with a width of 32 bits. It is easy to understand that the message header includes a reserved field of 12 bits. High-order 32 bits of the message header in the transfer message with a width of 64 bits, that is, high-order 32 bits in the reserved field of the message header in the transfer message with a width of 64 bits, are used as a payload with a width of 32 bits. The payload in each transfer message with a width of 64 bits is converted into two payloads with a width of 32 bits according to high-order 32 bits and low-order 32 bits thereof.

To convert a transfer message with a width of 32 bits into a transfer message with a width of 64 bits, a message header in the transfer message with a width of 32 bits is used as low-order 32 bits in a message header with a width of 64 bits. A payload of the transfer message with a width of 32 bits is used as high-order 32 bits in the message header with a width of 64 bits. If the transfer message with a width of 32 bits does not include a payload, the high-order 32 bits in the message header with a width of 64 bits after conversion are all set to 0. The payloads in every two transfer messages with widths of 32 bits are converted into a payload with a width of 64 bits. If only the payload in one transfer message with a width of 32 bits finally remains, high-order 32 bits of the final payload with a width of 64 bits are all set to 0.

According to the embodiments, when the transfer message is produced and consumed respectively in systems with different bus widths, efficient transmission of the transfer message can also be guaranteed.

In some embodiments, the buffer processing unit further includes: one or more message filters, and the message filters respectively correspond to different buffer address segments in the receive buffer. The one or more message filters are each configured to receive the transfer message from the internal routing unit, filter the received transfer message based on a respective filtering rule, and write a filtered transfer message to the corresponding buffer address segment.

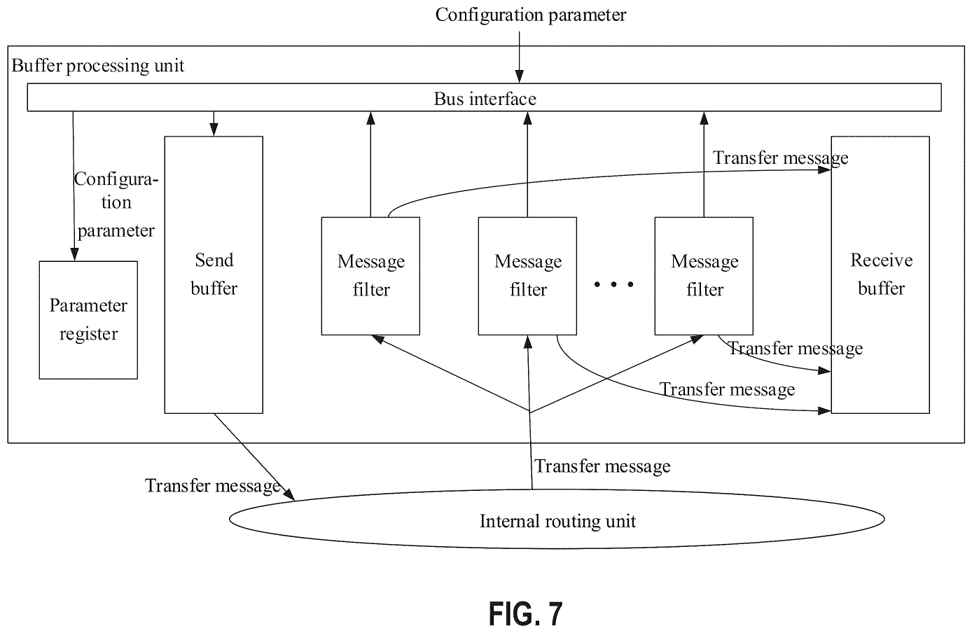

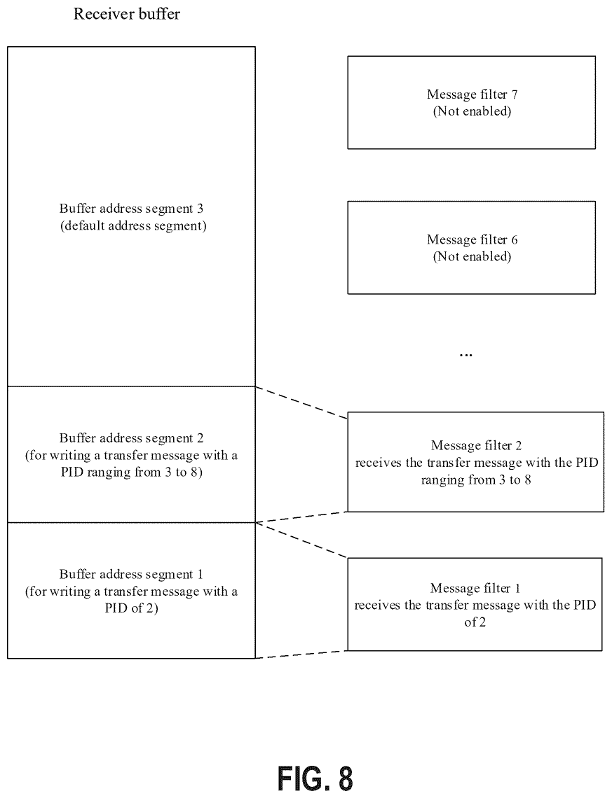

FIG. 7 is a schematic diagram of configuration of a buffer processing unit according to embodiments of the present disclosure. FIG. 8 is a schematic diagram of an example of a corresponding relationship between message filters and buffer address segments in a receive buffer according to embodiments of the present disclosure.

As shown in FIG. 7, the buffer processing unit includes one or more message filters. As shown in FIG. 8, the message filters respectively correspond to different buffer address segments in the receive buffer in the buffer processing unit where the message filters are located. Each message filter is configured with a predetermined filtering rule. The message filter receives transfer messages from the internal routing unit and filters the received transfer messages. Filtering the transfer messages means selecting (retaining) the transfer messages meeting the predetermined filtering rules from the received messages. The message filter then writes the filtered transfer messages (that is, the transfer messages meeting a predetermined rule of the message filter) into the buffer address segment corresponding to the message filter. That is, the filtered transfer messages are buffered in the corresponding buffer address segment. The message filter may be implemented by a logic circuit.

The filtering rule may be filtering one or more fields in the message header of the transfer message, for example, a producer core identifier field, a length field, or a reserved field within a certain range. The filtering rule may alternatively be filtering the payload of the transfer message, for example, a payload meeting a predetermined condition. It is easy to understand that the filtering rule of one message filter can apply one or more filtering conditions simultaneously.

In some examples, as shown in FIG. 8, the receive buffer further includes a default address segment, and transfer messages not selected by any of the one or more message filters in the buffer processing unit may be written into the default address segment. For example, the buffer processing unit further includes a default filter, and the default filter corresponds to the default address segment. The transfer messages not selected by any of the one or more message filters in the buffer processing unit may enter the default filter, so as to be written into the default address segment.

In some examples, by configuring the filtering rules of the one or more message filters, the buffer processing unit may further determine whether to receive a specific transfer message. For example, the transfer messages not selected by any of the one or more message filters in the buffer processing unit may be discarded, so as not to be written into the receive buffer. In this way, the buffer processing unit can discard transfer messages sent from a specific producer core, so that the consumer core corresponding to the buffer processing unit does not receive the transfer messages sent from the specific producer core.

In the above example, by configuring the buffer processing unit, whether the transfer message that is not selected by any of the one or more message filters in the buffer processing unit enters the default filter or is discarded may be set. The configuration of the buffer processing unit is achieved by applying configuration parameters of the buffer processing unit to the buffer processing unit to modify the actual operating circuit structure and logic thereof.

In some examples, when a memory space in any buffer address segment of the receive buffer has reached an occupancy limit, for instance, when the memory space is fully occupied, no transfer message is written into the buffer address segment, and a transfer message to be written into the buffer address segment will be discarded, thereby preventing data congestion and logical anomalies in the inter-core communication system. That is, a transfer message originally to be buffered to the buffer address segment is discarded due to an insufficient memory space in the receive buffer, and therefore cannot be successfully transmitted to the consumer core. Correspondingly, to prevent discarding of the transfer message due to an insufficient memory space in the receive buffer, whether the transfer message is received by the consumer core may be monitored by software, and a corresponding timeout-based retransmission mechanism is configured.

According to the embodiments, specific transfer messages may be distinguished from other transfer messages, facilitating management and use by the consumer core.

In some embodiments, the buffer processing unit is further configured to receive configuration parameters, and set, based on the configuration parameters, actually enabled message filters, a filtering rule of each message filter, and ranges of the buffer address segments.

Referring to FIG. 7 again, the buffer processing unit may further include one or more parameter registers. The parameter register is, for example, a control state register, which receives and stores configuration parameters for configuring the buffer processing unit where the parameter register is located. The buffer processing unit modifies an actual operating circuit structure and logic thereof according to the configuration parameters stored in the parameter register, thereby implementing the configuration of the buffer processing unit. FIG. 7 illustrates only a parameter register included in a buffer processing unit. However, in some examples, some of the one or more parameter registers may be located in the message filters, to configure the message filters where the parameter registers are located. More specifically, each message filter includes a parameter register.

An address space of each buffer processing unit is divided into two parts. One part is used to access one or more parameter registers. When writing configuration parameters into the buffer processing unit, the processor core writes the configuration parameters into the parameter registers by addressing the part of the address space. The other part is used to access the send buffer and the receive buffer. When accessing the send buffer or the receive buffer, the processor core accesses the send buffer or the receive buffer by addressing the part of the address space. In this example, to flexibly support page tables of different sizes and address attributes, the two parts of the address space each occupy 64 K, and one buffer processing unit occupies an address space of 128 K.

According to an actual requirement, the filtering rule of each message filter, which message filter(s) in the buffer processing unit is/are actually enabled, and a range of each buffer address segment (e.g., start and end addresses of each buffer address segment) may be configured. For example, if a certain type of transfer message is expected to have a large capacity, the buffer address segment into which the transfer messages are to be written may be set to a larger address segment range. In other words, the actual operating circuit structure and logic of the buffer processing unit may be configured according to an actual requirement. Each enabled message filter has a buffer address segment corresponding thereto, and address ranges of the buffer address segments corresponding to the enabled message filters do not overlap.

It is easy to understand that n-1 enabled message filters correspond to n-1 buffer address segments in the receive buffer, and the receive buffer may include another default address segment used for writing transfer messages not selected by the n-1 enabled message filters. Therefore, in this case, the receive buffer includes n buffer address segments, and the buffer address segments are consecutive and do not overlap. Correspondingly, the transfer messages are classified into n types. One buffer address segment corresponds to one type of transfer message.

As shown in FIGS. 8, 7 message filters are integrated in one buffer processing unit, of which 2 message filters (a message filter 1 and a message filter 2) are actually enabled. Filtering rules of the message filter 1 and the message filter 2 are respectively selecting transfer messages with a producer core identifier field PID of 2 and a producer core identifier field PID in a range of 3 to 8. The transfer messages selected by the two message filters may be respectively written into a buffer address segment 1 and a buffer address segment 2 in the receive buffer. Transfer messages not selected by any enabled message filter may be collectively written into a buffer address segment 3, which serves as the default address segment.

According to the embodiments, the buffer processing units may be configured according to an actual requirement, making filtering of the transfer messages flexibly adaptable to different application scenarios.

In some embodiments, each message filter includes one or more filtering units, and the filtering units respectively filter different parts of the transfer message based on respective filtering algorithms, to obtain unit filtering results of the filtering units. The buffer processing unit is further configured to set actually enabled filtering units in each message filter based on the configuration parameters, and apply rules of the unit filtering results of the filtering units in the message filter, to set the filtering rule of each message filter.

For example, each message filter includes one or more message header filtering units configured to filter message headers of transfer messages, and one or more payload filtering units configured to filter payloads of the transfer messages. Each filtering unit is configured with a corresponding filtering algorithm. The filtering algorithms act on the message headers of the transfer messages and corresponding payloads, respectively. Each filtering unit may be individually configured as enabled or disabled. The buffer processing unit configures, according to the received configuration parameters, which filtering unit(s) in a message filter is/are actually enabled.

A rule of applying the unit filtering results of the filtering units in the message filter means how to apply the unit filtering results to obtain a final filtering result of the message filter. For example, the results of the unit filtering units may be configured to perform an AND or OR operation to produce the final filtering result. The buffer processing unit configures, according to the received configuration parameters, the rule of applying the unit filtering results of the filtering units in the message filter.

According to the embodiments, by configuring the filtering units, the actual operating circuit structure and logic of the message filter can be easily configured, thereby flexibly configuring the filtering rule of each message filter.

In some embodiments, the buffer processing unit is further configured to send, in response to a number of the transfer message in any buffer address segment of the receive buffer in the buffer processing unit being greater than or equal to the predetermined number, an interrupt signal corresponding to the buffer address segment to the processor core corresponding to the buffer processing unit, to enable the processor core to serve as the consumer core to read the transfer message from the buffer address segment that is in the receive buffer and corresponds to the interrupt signal. Interrupt signals corresponding to different buffer address segments have different interrupt priorities.

In the embodiments, each buffer address segment has an independent interrupt mechanism. That is, each type of transfer message has an independent interrupt mechanism. The number of the transfer message in a buffer address segment in the receive buffer in the buffer processing unit being greater than or equal to the predetermined number means that a specific type of transfer message is transmitted into the receive buffer and a number of the specific type of transfer message in the receive buffer is greater than or equal to the predetermined number. In this case, the buffer processing unit sends an interrupt signal to the consumer core to notify the consumer core to read the transfer message from the buffer address segment.

“Interrupt signals corresponding to different buffer address segments have different interrupt priorities” means that the consumer core processes the interrupt signals corresponding to different buffer address segments with different priorities. The priorities of the interrupt signals may be configured by an interrupt controller. That is, the interrupt controller sets different priorities for the interrupt signals corresponding to different buffer address segments. It is easy to understand that the interrupt controller may alternatively set that the interrupt signals corresponding to the plurality of buffer address segments have a same priority.

For example, when a number of transfer messages buffered in the buffer address segment 1 in the receive buffer is greater than or equal to the predetermined number, regardless of numbers of transfer messages in the buffer address segment 2 or 3, an interrupt signal corresponding to the buffer address segment 1 is sent to the processor core corresponding to the buffer processing unit. In response to receiving the interrupt signal, the processor core, acting as a consumer core, reads the transfer message from the buffer address segment 1 of the receive buffer. In addition, the interrupt controller may set the priority of the interrupt signal corresponding to the buffer address segment 1 to be greater than the priority of the interrupt signal corresponding to the buffer address segment 2 and set the priority of the interrupt signal corresponding to the buffer address segment 2 to be greater than the priority of the interrupt signal corresponding to the buffer address segment 3. In this way, when receiving a plurality of interrupt signals simultaneously, the processor core prioritizes processing the interrupt signal with a higher priority. By setting different priorities for the interrupt signals corresponding to different buffer address segments, specific transfer messages can be distinguished from other transfer messages, and priorities of the specific transfer messages can be increased, so that the consumer core can prioritize processing the specific transfer messages.

According to the embodiments, the processor core as a consumer core can easily distinguish different types of transfer messages and set different priorities for the different types of transfer messages, thereby processing the transfer messages according to a requirement.

In some embodiments, the buffer processing unit is further configured to: calculate a send check code based on the transfer message written into the send buffer, and append the send check code to the transfer message; and calculate a receive check code based on the transfer message written into the receive buffer, and compare the receive check code with the send check code appended to the transfer message, to determine whether a transmission error occurs in the transfer message.

As described above, the message buffer module in the subsystem where the producer core is located writes the transfer message into the send buffer of the buffer processing unit corresponding to the producer core. In this case, the buffer processing unit starts receiving the writing of the transfer message from the message header of the transfer message and waits until the transfer message is completely received. During the writing of the transfer message into the send buffer, the buffer processing unit calculates the send check code and appends the send check code to the transfer message, so that the send check code is transmitted together with the transfer message. The transfer message and the send check code appended thereto are finally transmitted to the buffer processing unit corresponding to the consumer core and are written into the receive buffer in the buffer processing unit corresponding to the consumer core.

The buffer processing unit corresponding to the consumer core receives the transfer message to which the send check code is appended. More specifically, the transfer message to which the send check code is appended is written into the receive buffer in the buffer processing unit corresponding to the consumer core. In this case, the buffer processing unit calculates the receive check code based on the received transfer message, and compares the calculated receive check code with the send check code appended to the received transfer message. If the send check code is consistent with the receive check code, it may be considered that the transfer message is correct. If the send check code is inconsistent with the receive check code, it may be considered that a transmission error occurs in the transfer message. If a transmission error occurs, the producer core may be notified to perform retransmission.

The check code may be an error-correcting code (ECC), which is an encoding technology for data transmission. During the transmission over the hardware link in the SoC, the transfer message is easily affected by noise interference, attenuation, and the like, leading to transmission errors. The calculation of the ECC can reduce a bit error rate and improve communication reliability.

According to the embodiments, reliability of the transfer message during the transmission of inter-core communication can be ensured.

In some embodiments, a plurality of subsystems are classified into one or more subsystem clusters according to implemented functions and locations, each subsystem cluster corresponds to one message routing module, and each subsystem is connected to the message routing module corresponding to the subsystem cluster to which the subsystem belongs.

Referring to FIG. 1 again, in the example of FIG. 1, the subsystems A, B, and C form a subsystem cluster, corresponding to the message routing module X, and the subsystems A, B, and C are all connected to the message routing module X. The subsystems D, E, F, and G form a subsystem cluster, corresponding to the message routing module Y, and the subsystems D, E, F, and G are all connected to the message routing module Y. The subsystems H and I form a subsystem cluster, corresponding to the message routing module Z, and the subsystems H and I are both connected to the message routing module Z.

It is easy to understand that when the transfer message is transmitted between different subsystem clusters, that is, when the producer core and the consumer core are not located in a same subsystem cluster, the transfer message is transferred from the message routing module corresponding to the subsystem where the producer core is located, through connections between a plurality of message routing modules, to the message routing module corresponding to the subsystem where the consumer core is located.

In the design of the SoC, functionally closely related subsystems are located close to each other in the SoC to reduce transmission paths of signals or data. For example, a GPU subsystem responsible for graphics processing, an ISP subsystem responsible for image signal processing, and a codec subsystem responsible for video encoding and decoding are all closely related to vision-related tasks. These subsystems can be located close to each other. When capturing a video, the ISP subsystem captures and performs preliminary processing on image signals, which can then be quickly transmitted to the codec subsystem for compression into an appropriate format or to the GPU subsystem for special effects rendering, reducing loss and latency of data during long-distance transmission.

Further, the message routing module may be deployed close to each subsystem in the subsystem cluster corresponding thereto, thereby reducing a transmission distance of the transfer message between the subsystem and the message routing module.

According to the embodiments, a plurality of subsystems are classified into one or more subsystem clusters based on implemented functions and locations, and subsystems with closely related functions and close locations are classified into the same subsystem cluster, thereby improving the efficiency of inter-subsystem collaboration. In addition, different subsystem clusters have varying requirements for resources (such as power and bandwidth) at runtime. The deployment of the subsystem cluster and the message routing module may be adjusted according to an actual requirement. Through the classification into different subsystem clusters, the SoC can precisely adjust resource allocation according to real-time requirements of the subsystem clusters, and flexibly enable or disable some subsystem clusters to save power. In addition, each subsystem cluster corresponds to one message routing module, and each subsystem is connected to the message routing module corresponding to the subsystem cluster to which the subsystem belongs. In this way, a transmission path of the transfer message between each message buffer module and the message routing module may be minimized, which reduces a risk of electromagnetic interference and improves transmission efficiency of the transfer message.

In some embodiments, a predetermined watermark may be set for the send buffer in the buffer processing unit. When an amount of the transfer message in the send buffer is below the watermark, the buffer processing unit may send an interrupt signal to the processor core corresponding thereto to notify the processor core to serve as a producer core to continuously send the transfer message. The amount of the transfer message in the send buffer being below the watermark means that the send buffer has ample free capacity, making the transfer message unlikely to overflow. In this case, the producer core can be further prompted to continuously send the transfer message. The predetermined watermark may be a predetermined percentage of an overall capacity of the send buffer.

According to the inter-core communication system of the present disclosure, the transmission process of the transfer message is transparent to software running on the processor core. This means that software-level applications running on the processor core are not required to be concerned with the transmission process of the transfer message, which directly acquire a transmission result of the transfer message.

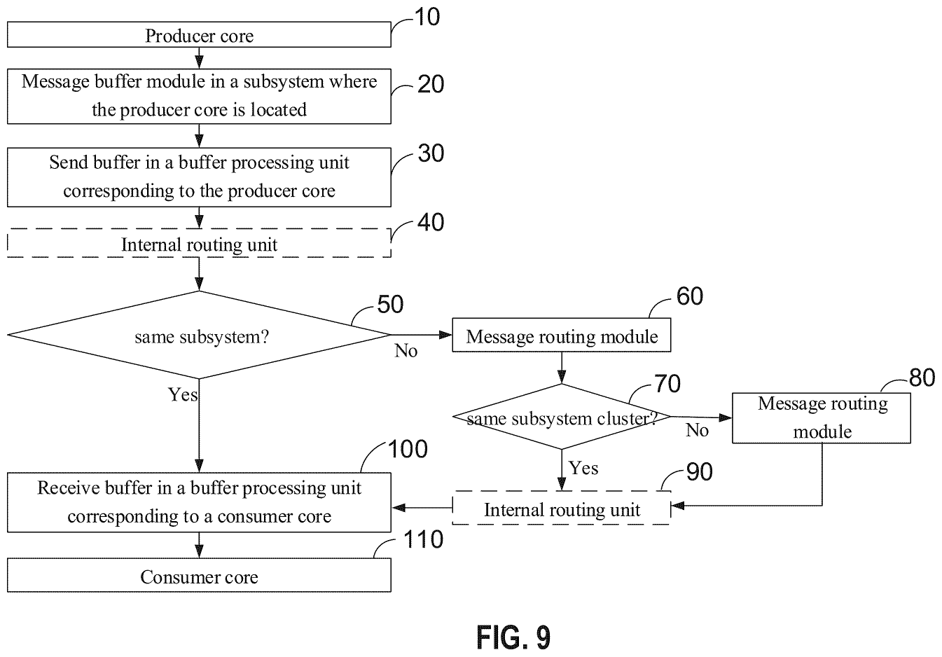

FIG. 9 is a schematic diagram of a communication process of a transfer message in an inter-core communication system according to embodiments of the present disclosure. The communication process of the transfer message in the inter-core communication system according to the present disclosure is described below with reference to FIG. 9. Arrows in FIG. 9 indicate transmission routes of the transfer message.

In step 10, a producer core generates a transfer message.

In step 20, the producer core writes, via a bus, the transfer message into a message buffer module in a subsystem where the producer core is located, and the message buffer module receives the transfer message via a bus interface thereof.

In step 30, the message buffer module processes, via address decoding logic, the received transfer message to identify the producer core from which the transfer message originates, so as to write the transfer message into a send buffer in a buffer processing unit corresponding to the producer core. At the same time, the buffer processing unit corresponding to the producer core calculates a send check code based on the written transfer message, and appends the send check code to the transfer message.

In step 40, the send buffer in the buffer processing unit transmits the transfer message, to which the send check code is appended, to an internal routing unit in the message buffer module where the buffer processing unit is located, and the internal routing unit receives the transfer message.

In step 50, the internal routing unit determines, based on the transfer message, the producer core from which the transfer message originates and a consumer core to which the transfer message is to be transferred, and when the producer core and the consumer core are located in different subsystems, the communication process proceeds to step 60. When the producer core and the consumer core are located in the same subsystem, the communication process proceeds to step 100, and it is easy to understand that, in this case, the buffer processing unit corresponding to the consumer core and the buffer processing unit corresponding to the producer core are located in the same message buffer module.

In step 60, the acquired transfer message is routed to the message routing module connected to the internal routing unit, that is, routed to the message routing module connected to the subsystem where the producer core is located. The message routing module receives the transfer message.

In step 70, the message routing module determines whether the consumer core to which the transfer message is to be transferred is located in a subsystem cluster corresponding to the message routing module. When the consumer core is not located in the subsystem cluster corresponding to the message routing module, the communication process proceeds to step 80, and when the consumer core is located in the subsystem cluster corresponding to the message routing module, the communication process proceeds to step 90.

In step 80, the message routing module routes the transfer message to a message routing module connected to the subsystem where the consumer core is located, and the communication process proceeds to step 90.

In step 90, the message routing module routes the transfer message to the internal routing unit in the message buffer module connected to the subsystem where the consumer core is located, and the internal routing unit receives the transfer message.

In step 100, the internal routing unit transmits the transfer message to the buffer processing unit corresponding to the consumer core. The buffer processing unit receives the transfer message, filters the transfer message via one or more message filters, and writes the filtered transfer message into a corresponding address segment in the receive buffer. The buffer processing unit sends an interrupt signal to the consumer core.

In step 110, the consumer core acquires the transfer message from the receive buffer in the corresponding buffer processing unit.

In FIG. 9, step 40 is shown with a dashed line because, if the message buffer module in the subsystem where the producer core is located includes only one buffer processing unit, the buffer processing unit may transmit the transfer message directly to the message routing module without passing through the internal routing unit. Similarly, step 90 is shown with a dashed line because, if a message buffer module in a subsystem where the consumer core is located includes only one buffer processing unit, the message routing module may transmit the transfer message directly to the buffer processing unit without passing through the internal routing unit.

In another aspect of the present disclosure, a chip circuit is provided, including the inter-core communication system in the embodiments described above. For example, the chip circuit may be an SoC chip.

In yet another aspect of the present disclosure, a chip circuit is provided, including: one or more processor cores, a transfer message being transmitted between the one or more processor cores, and one or more buffer processing units in one-to-one correspondence to the one or more processor cores. Each buffer processing unit includes: a parameter register configured to store configuration parameters for configuring the buffer processing unit, a send buffer configured to buffer a transfer message to be sent by the processor core corresponding to the buffer processing unit where the send buffer is located, and a receive buffer configured to buffer a transfer message to be received by the processor core corresponding to the buffer processing unit where the receive buffer is located. An address space in each buffer processing unit is divided into two parts, one part is used to access the parameter register, and the other part is used to access the send buffer and the receive buffer.

The functions and the features of the processor core and the buffer processing unit described in the foregoing embodiments can be applied to the processor core and the buffer processing unit according to the aspect. Details are not described herein again.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. An inter-core communication system, comprising:
one or more subsystems, each of the subsystems comprising:
a message buffer circuit, and
one or more processor cores respectively connected to the message buffer circuit via a bus, each of the processor cores serving as a producer core or a consumer core, the producer core being configured to write a transfer message into the message buffer circuit integrated in the subsystem where the producer core is located, and the consumer core being configured to read the transfer message from the message buffer circuit integrated in the subsystem where the consumer core is located; and
one or more message routing circuits configured to:
acquire the transfer message written by the producer core into the message buffer circuit integrated in the subsystem where the producer core is located, and
route the acquired transfer message to the message buffer circuit integrated in the subsystem where the consumer core is located.

2. The inter-core communication system according to claim 1, wherein each of the message buffer circuits in a respective subsystem comprises:
one or more buffer processing subcircuits, each corresponding to one of one or more processor cores in the respective subsystem, each of the one or more buffer processing subcircuits comprising a send buffer and a receive buffer; and
an internal routing subcircuit configured to:
acquire the transfer message, and
route the transfer message to the receive buffer of the buffer processing subcircuit in the message buffer circuit;
wherein the consumer core in the respective subsystem is configured to read the transfer message from the receive buffer in the buffer processing subcircuit.

3. The inter-core communication system according to claim 2, wherein
the message buffer circuit is further configured to write the transfer message into the send buffer in the buffer processing subcircuit corresponding to the producer core, the send buffer being configured to transfer the transfer message to the internal routing subcircuit;
the internal routing subcircuit is further configured to
acquire the transfer message from the send buffer in the buffer processing subcircuit, and
route, if the producer core and the consumer core are located in the same subsystem, the acquired transfer message to the receive buffer in the buffer processing subcircuit corresponding to the consumer core; or route, if the producer core and the consumer core are located in different subsystems, the acquired transfer message to the message routing circuit; and
the message routing circuit is further configured to route the acquired transfer message to the internal routing subcircuit in the message buffer circuit in the subsystem where the consumer core is located.

4. The inter-core communication system according to claim 3, wherein
the internal routing subcircuit is further configured to acquire the transfer message from the message routing circuit, and route the transfer message to the receive buffer in the buffer processing subcircuit corresponding to the consumer core.

5. The inter-core communication system according to claim 2, wherein
the buffer processing subcircuit is further configured to send, in response to a number of the transfer message in the receive buffer in the buffer processing subcircuit being greater than or equal to a predetermined number, an interrupt signal to the processor core corresponding to the buffer processing subcircuit, to enable the processor core to serve as the consumer core to read the transfer message from the receive buffer.

6. The inter-core communication system according to claim 2, wherein the transfer message comprises:
a producer core identifier field configured to identify the producer core from which the transfer message originates, and
a consumer core identifier field configured to identify the consumer core to which the transfer message is to be sent.

7. The inter-core communication system according to claim 6, wherein the internal routing subcircuit is further configured to:
discard the transfer message when both the producer core indicated by the producer core identifier field in the transfer message and the consumer core indicated by the consumer core identifier field in the transfer message are not located in the subsystem where the internal routing subcircuit is located.

8. The inter-core communication system according to claim 6, wherein the producer core identifier field is configured to
identify a message buffer circuit in the subsystem where the producer core is located and a buffer processing subcircuit corresponding to the producer core, and
wherein the consumer core identifier field is configured to identify a message buffer circuit in the subsystem where the consumer core is located and a buffer processing subcircuit corresponding to the consumer core.

9. The inter-core communication system according to claim 2, wherein
the buffer processing subcircuit is further configured to convert a format of the transfer message in the receive buffer in the buffer processing subcircuit based on a width of the bus connecting the message buffer circuit to the one or more processor cores.

10. The inter-core communication system according to claim 2, wherein the buffer processing subcircuit further comprises: one or more message filters, each of the message filters corresponding to a respective buffer address segment of buffer address segments in the receive buffer;
wherein each of the one or more message filters is configured to receive the transfer message from the internal routing subcircuit, filter the received transfer message based on a respective filtering rule, and write a filtered transfer message to the corresponding buffer address segment.

11. The inter-core communication system according to claim 10, wherein
the buffer processing subcircuit is further configured to
receive configuration parameters, and
set, based on the configuration parameters, message filters to be actually enabled, a filtering rule for each of the one or more message filters, and ranges of the buffer address segments.

12. The inter-core communication system according to claim 11, wherein
each of the one or more message filters comprises one or more filtering subcircuits, each of the filtering subcircuits filtering a different part of the transfer message based on a respective filtering algorithm, to obtain a respective subcircuit filtering result of the filtering subcircuits; and
the buffer processing subcircuit is further configured to
set a subset of the one or more filtering subcircuits that are actually enabled in each of the one or more message filters based on the configuration parameters, and
apply rules of the respective subcircuit filtering results of the filtering subcircuits in the message filter, to set the filtering rule of each of the one or more message filters.

13. The inter-core communication system according to claim 10, wherein the buffer processing subcircuit is further configured to
send, in response to a number of the transfer message in a buffer address segment of the receive buffer in the buffer processing subcircuit being greater than or equal to a predetermined number, an interrupt signal corresponding to the buffer address segment to the processor core corresponding to the buffer processing subcircuit, to enable the processor core to serve as the consumer core to read the transfer message from the buffer address segment that is in the receive buffer and corresponds to the interrupt signal; and
interrupt signals corresponding to different buffer address segments with different interrupt priorities.

14. The inter-core communication system according to claim 2, wherein the buffer processing subcircuit is further configured to:
calculate a send check code based on the transfer message written into the send buffer, and append the send check code to the transfer message; and
calculate a receive check code based on the transfer message written into the receive buffer, and compare the receive check code with the send check code appended to the transfer message, to determine whether a transmission error occurs in the transfer message.

15. The inter-core communication system according to claim 1, wherein
a plurality of subsystems are classified into one or more subsystem clusters according to respective implemented functions and locations, each of the one or more subsystem clusters corresponding to one message routing circuit, and each of the plurality of subsystems being connected to the message routing circuit corresponding to the subsystem cluster to which the subsystem belongs.

16. A chip, comprising an inter-core communication system comprising:
one or more subsystems, each of the subsystems comprising:
a message buffer circuit, and
one or more processor cores respectively connected to the message buffer circuit via a bus, each of the processor cores serving as a producer core or a consumer core, the producer core being configured to write a transfer message into the message buffer circuit integrated in the subsystem where the producer core is located, and the consumer core being configured to read the transfer message from the message buffer circuit integrated in the subsystem where the consumer core is located; and
one or more message routing circuits configured to:
acquire the transfer message written by the producer core into the message buffer circuit integrated in the subsystem where the producer core is located, and
route the acquired transfer message to the message buffer circuit integrated in the subsystem where the consumer core is located.

17. A chip, comprising:
one or more processor cores, a transfer message being transmitted between the one or more processor cores; and
one or more buffer processing subcircuits in one-to-one correspondence to the one or more processor cores, each of the buffer processing subcircuits comprising:
a parameter register configured to store configuration parameters for configuring the buffer processing subcircuit;
a send buffer configured to buffer a transfer message to be sent by the processor core corresponding to the buffer processing subcircuit where the send buffer is located; and
a receive buffer configured to buffer a transfer message to be received by the processor core corresponding to the buffer processing subcircuit where the receive buffer is located;
wherein an address space in each of the one or more buffer processing subcircuits is divided into two parts, one part used to access the parameter register, and the other used to access the send buffer and the receive buffer.

18. The chip according to claim 16, wherein each of the message buffer circuits in a respective subsystem comprises:
one or more buffer processing subcircuits, each corresponding to one of one or more processor cores in the respective subsystem, each of the one or more buffer processing subcircuits comprising a send buffer and a receive buffer; and
an internal routing subcircuit configured to:
acquire the transfer message, and
route the transfer message to the receive buffer of the buffer processing subcircuit in the message buffer circuit;
wherein the consumer core in the respective subsystem is configured to read the transfer message from the receive buffer in the buffer processing subcircuit.

19. The chip according to claim 18, wherein
the message buffer circuit is further configured to write the transfer message into the send buffer in the buffer processing subcircuit corresponding to the producer core, the send buffer being configured to transfer the transfer message to the internal routing subcircuit;
the internal routing subcircuit is further configured to
acquire the transfer message from the send buffer in the buffer processing subcircuit, and
route, if the producer core and the consumer core are located in the same subsystem, the acquired transfer message to the receive buffer in the buffer processing subcircuit corresponding to the consumer core; or route, if the producer core and the consumer core are located in different subsystems, the acquired transfer message to the message routing circuit; and
the message routing circuit is further configured to route the acquired transfer message to the internal routing subcircuit in the message buffer circuit in the subsystem where the consumer core is located.

20. The chip according to claim 19, wherein
the internal routing subcircuit is further configured to acquire the transfer message from the message routing circuit, and route the transfer message to the receive buffer in the buffer processing subcircuit corresponding to the consumer core.
